(19) United States
(12) Patent Application Publication
(10) Pub. No.: US 2025/0019504 A1
(43) Pub. Date: Jan. 16, 2025

(54) FIBER COMPOSITE MATERIAL REINFORCED AND TOUGHENED BY LONG-SHORT CARBON NANOTUBES AND PREPARATION METHOD THEREOF

(71) Applicant: NINGBO INSTITUTE OF MATERIALS TECHNOLOGY AND ENGINEERING, CHINESE ACADEMY OF SCIENCES, Ningbo, Zhejiang (CN)

(72) Inventors: Yunfu OU, Ningbo, Zhejiang (CN); Lingzhuang ZHU, Ningbo, Zhejiang (CN); Mengjie WANG, Ningbo, Zhejiang (CN); Longqiang WU, Ningbo, Zhejiang (CN); Dongsheng MAO, Ningbo, Zhejiang (CN)

(73) Assignee: NINGBO INSTITUTE OF MATERIALS TECHNOLOGY AND ENGINEERING, CHINESE ACADEMY OF SCIENCES, Ningbo, Zhejiang (CN)

(21) Appl. No.: 18/277,182

(22) PCT Filed: Apr. 13, 2022
(86) PCT No.: PCT/CN2022/086505

§ 371 Date: Aug. 14, 2023

(30) Foreign Application Priority Data
Feb. 17, 2022 (CN) 202210146054.3

(51) Int. Cl. C08J 5/00; C08K 7/06

(52) U.S. Cl. CPC C08J 5/005; C08K 7/06; C08J 2363/02; C08K 2201/004; C08K 2201/011

(57) ABSTRACT

The application provides a fiber composite material reinforced and toughened by long-short carbon nanotubes and preparation method thereof, comprising: a) mixing a short carbon nanotube, a thermoset resin and an additive, to obtain resin matrix slurry; b) pouring the resin matrix slurry into a fiber preform and curing-molding, to obtain the fiber composite material reinforced and toughened by long-short carbon nanotubes; the short carbon nanotube has a length of 0.5-3 μm and an average length of ≤2 μm; and the long carbon nanotube has a length of 50-1000 μm. The present disclosure optimizes the spatial layout of long and short carbon nanotubes in the composite material, simultaneously achieving the dual purposes of the intralaminar reinforcement and the interlaminar toughening of the fiber composite material.

This application claims the priority to Chinese Patent Application No. 202210146054.3, titled “FIBER COMPOSITE MATERIAL REINFORCED AND TOUGHENED BY LONG-SHORT CARBON NANOTUBES AND PREPARATION METHOD THEREOF”, filed on Feb. 17, 2022 with the China National Intellectual Property Administration, which is incorporated herein by reference in entirety.

### FIELD

The present disclosure relates to the field of composite materials, and particularly relates to a fiber composite material reinforced and toughened by long-short carbon nanotubes and preparation method thereof.

### BACKGROUND

Fiber-reinforced polymer (FRP) composites have developed rapidly in the past half century. With higher specific stiffness, strength and excellent fatigue performance and corrosion resistance, they have been widely used in aircraft, automobiles, civil, ships and offshore platform facilities, etc. Upon a large demand for composite materials in the international market, a number of terminal products based on composite materials have been put on the market in large quantities. Nano-reinforced composite materials have performances capable of reducing matrix weight, and replacing expensive carbon fibers and synthetic fibers in composite materials, providing sustainable competitive advantages in fields such as aerospace, automotive, and energy. Developing high-performance nano-reinforced composite materials has become an important application direction in this field. Carbon nanotubes are one of the strongest materials found on the earth so far, which have a tensile strength 20 times as high as that of a high-strength steel, a Young's modulus that is one order of magnitude higher than carbon fibers and that is 100 times as high as a steel. Such super mechanical properties, excellent electrical, chemical and thermal stability enable carbon nanotubes to play a multi-faceted role in developing super-strong composite materials. However, there are still many technical bottlenecks, for example, the large aspect ratio and high specific surface area make it difficult for CNT to be uniformly dispersed in the resin matrix, and a small amount of CNTs will greatly significantly increase the viscosity of the resin, resulting in difficulties in resin introduction and fiber preform infiltration.

With respect to carbon nanotube-reinforced continuous fiber composite materials, how to make carbon nanotubes successfully pass through the narrow gaps between continuous fibers and evenly disperse in the composite material is an urgent problem to be solved. Carbon fibers typically have a diameter of 5-10 micrometers. A composite material contains carbon fibers at an amount of up to 55% or more, resulting in a better performance, and allowing carbon fibers to act better. FIG. 1 is a cross-section view showing a carbon fiber epoxy resin composite material, wherein carbon fibers would be present in the composite material in an fraction of 55% by volume, provided that they have a diameter of 7 micrometers (e.g., T700 carbon fiber produced by Toray, Japan); and the distance between adjacent carbon fibers would be less than 2 micrometers, provided at the same time that carbon fibers are evenly distributed in the epoxy resin matrix. Since commercial carbon nanotubes typically have a length ranging from 20 to 100 micrometers, carbon nanotubes cannot pass through the gaps of carbon fibers at all, causing a problem of “fiber filtration effect”. If it is failed to solve this problem, the mechanical properties of a fiber composite material will be hardly to be improved.

In addition, fiber composite materials are usually used in the form of laminated products. Due to their laminated structure characteristics and intrinsic brittleness of the resin matrix, fiber composite materials have a lower bearing capacity along the thickness direction, and easily undergo delamination damage under the loads such as in-plane compression, bending, fatigue and transverse impact. Once delamination starts and propagates inside laminated plates, the stiffness of the entire structure will gradually decrease, eventually leading to catastrophic failure. Therefore, improving their interlaminar fracture toughness is crucial in many engineering applications.

### SUMMARY

In view of that, an object of the present disclosure is to provide a fiber composite material reinforced and toughened by long-short carbon nanotubes and preparation method thereof. The fiber composite material reinforced and toughened by long-short carbon nanotubes provided by the present disclosure can simultaneously realize matrix reinforcement and interlaminar toughening of the composite material.

The present disclosure provides a method of preparing a fiber composite material reinforced and toughened by long-short carbon nanotubes, comprising steps of:
a) mixing a short carbon nanotube, a thermoset resin and an additive, to obtain resin matrix slurry;
b) pouring the resin matrix slurry into a fiber preform and curing-molding, to obtain the fiber composite material reinforced and toughened by long-short carbon nanotubes; wherein
the fiber preform comprises an upper fiber fabric layer, a long carbon nanotube fiber veil layer and a lower fiber fabric layer, which are sequentially laminated and contacted;
the long carbon nanotube fiber veil layer has a veil-like structure formed by the long carbon nanotube;
the short carbon nanotube has a length of 0.5-3 μm and an average length of ≤2 μm; and
the long carbon nanotube has a length of 50-1000 μm.

Preferably, the short carbon nanotube is a non-surface modified short carbon nanotube or a surface modified short carbon nanotube;
the long carbon nanotube is a non-surface modified long carbon nanotube or a surface modified long carbon nanotube;
a surface modifying functional group in the surface modified short carbon nanotube is selected from the group consisting of amino, carboxyl, carbonyl and combinations thereof; and
a surface modifying functional group in the surface modified long carbon nanotube is selected from the group consisting of amino, carboxyl, carbonyl and combinations thereof.

Preferably, the thermoset resin is selected from the group consisting of an epoxy resin, a polyester resin, a phenolic resin, a vinyl resin, a bismaleimide resin and combinations thereof.

Preferably, the short carbon nanotube is 0.1%-5% by mass of the thermoset resin;
the long carbon nanotube is 0.1%-5% by mass of the thermoset resin; and
a total mass of the upper fiber fabric and the lower fiber fabric is 40%-80% by mass of the composite material.

Preferably, the fiber fabric in the upper fiber fabric layer is a unidirectional fiber fabric or a multi-directional fiber fabric;
the fiber fabric in the lower fiber fabric layer is a unidirectional fiber fabric or a multi-directional fiber fabric;
the fiber fabric in the upper fiber fabric layer is a continuous carbon fiber fabric, a continuous glass fiber fabric or a continuous aramid fiber fabric;
the fiber fabric in the lower fiber fabric layer is a continuous carbon fiber fabric, a continuous glass fiber fabric or a continuous aramid fiber fabric;
the fiber fabric in the upper fiber fabric layer is a non-surface modified fiber fabric or a surface modified fiber fabric; and
the fiber fabric in the lower fiber fabric layer is a non-surface modified fiber fabric or a surface modified fiber fabric.

Preferably, the fiber fabric in the upper fiber fabric layer comprises one or more layers; and
the fiber fabric in the lower fiber fabric layer comprises one or more layers.

Preferably, the additive is a curing agent and/or an accelerating agent;
the curing agent is used in an amount of 1%-50% by mass of the thermoset resin; and
the accelerating agent is used in an amount of 0.1%-5% by mass of the thermoset resin.

Preferably, in step b), the pouring of the resin matrix slurry into a fiber preform is carried out by a vacuum assisted resin transfer molding process.

Preferably, the curing-molding in step b) is carried out at a temperature of 25-500° C. and a pressure of ≤10 MPa.

The present disclosure further provides a fiber composite material reinforced and toughened by long-short carbon nanotubes that is prepared by the method according to the above-mentioned technical solution.

In accordance with the preparation method provided by the present disclosure, during the mutual infiltration between resins and fibers, short carbon nanotubes can easily penetrate through the narrow gaps between fibers and be evenly dispersed in the composite material, and long carbon nanotubes are laid, in the form of fiber veils, on the surface of the fiber fabric, before the resin matrix slurry is poured. This effectively solves the problem of difficult dispersion of long carbon nanotubes, and effectively alleviates the “fiber filtration effect” of carbon nanotubes that often occurs in the VARTM process. The spatial layout of long and short carbon nanotubes in the composite material is optimized, namely, short carbon nanotubes will effectively pass through the narrow gaps between the fibers and are evenly distributed throughout the fiber composite plates, and the long carbon nanotubes are enriched in the interlaminar region of the composite material plates. This enables carbon nanotubes to fully exert their excellent mechanical properties, simultaneously achieving the dual purposes of the intralaminar reinforcement and the interlaminar toughening of the fiber composite material. In a word, the present invention not only effectively avoids the “fiber filtration effect” of carbon nanotubes generally occurring in the VARTM process, which enables the short carbon nanotubes to evenly disperse in the fiber composite material, and simultaneously to effectively fill the gaps between the fiber composite material layers or resin-enriched regions, but also effectively increases interfacial bonding forces between layers by reinforcing the connection between layers of the fiber composite material by the long carbon nanotubes, so that the prepared composite material has excellent mechanical properties such as strength and toughness and physical properties such as thermal and electrical properties.

The test results show that the composite material prepared by the present disclosure exhibited a bending strength equal to or greater than 600 MPa, which increased by 6% as compared with the reference sample, and a type I interlaminar fracture toughness equal to or greater than 1500 J/m², which increased by 150% as compared with the reference sample.

### BRIEF DESCRIPTION OF DRAWINGS

FIG. 1 a cross-section view showing a carbon fiber epoxy resin composite material;

FIG. 2 is a flow chart of the first method for preparing a long carbon nanotube fiber veil;

FIG. 3 is a flow chart of the second method for preparing a long carbon nanotube fiber veil;

FIG. 4 is a schematic graph showing the pouring of resin matrix slurry into a fiber preform by use of a vacuum assisted resin transfer molding process;

FIG. 5 is a schematic graph showing the laying structure of a fiber preform in Example 1;

FIG. 6 is an SEM image of a cured sample of resin matrix slurry obtained in step S3 of Example 1;

FIG. 7 is a schematic graph showing the preparation process in Example 1;

FIG. 8 is a typical load-displacement curve graph of the samples of Example 1 and Comparative Example 1;

FIG. 9 is a load-opening displacement curve graph of the samples of Example 1 and Comparative Example 1;

FIG. 10 is a R-curve (a curve of crack growth resistance against crack growth) graph of the samples of Example 1 and Comparative Example 1; and

FIG. 11 is an SEM image of the interlaminar structure of the fractured sample in Example 1.

### DETAILED DESCRIPTION

The present disclosure provides a method of preparing a fiber composite material reinforced and toughened by long-short carbon nanotubes. The method comprises:
step a), mixing a short carbon nanotube, a thermoset resin and an additive, to obtain resin matrix slurry; and
step b), pouring the resin matrix slurry into a fiber preform and curing-molding, to obtain the fiber composite material reinforced and toughened by long-short carbon nanotubes; wherein
the fiber preform comprises an upper fiber fabric layer, a long carbon nanotube fiber veil layer and a lower fiber fabric layer which are sequentially laminated and contacted;
the long carbon nanotube fiber veil layer has a veil-like structure formed by the long carbon nanotube;
the short carbon nanotube has a length of 0.5-3 μm and an average length of ≤2 μm; and
the long carbon nanotube has a length of 50-1000 μm.
   [Regarding Step a]

A short carbon nanotube, a thermoset resin and an additive are mixed to obtain resin matrix slurry.

In accordance with the present disclosure, the raw materials forming the resin matrix slurry include a short carbon nanotube.

In the present disclosure, the short carbon nanotube has a length distribution ranging from 0.5 to 3 μm and an average length of ≤2 μm. In the present disclosure, the short carbon nano-fiber tube preferably has a diameter of 1-50 nm. In the present disclosure, the short carbon nanotube is obtained by truncating a carbon nanotube. The source of the carbon nanotube is not limited. The carbon nanotube can be commercially available or prepared according to conventional preparation methods in this field. The truncating can be carried out in a manner including mechanical ball milling or chemical wet etching. The chemical wet etching preferably includes: placing carbon nanotubes in an etching solution for ultrasonic treatment, so as to obtain truncated carbon nanotubes with a controllable length. Specifically, the length of the carbon nanotubes can be adjusted by controlling the conditions of the ultrasonic treatment. In some embodiments of the present disclosure, carbon nanotubes are placed in aqua regia, and ultrasonically treated at 70° C. to obtain short carbon nanotubes with a length distribution of 0.5-3 μm and an average length of ≤2 μm.

In the present disclosure, the short carbon nanotube has purity preferably equal to or greater than 95%.

In the present disclosure, the short carbon nanotube is a non-surface modified short carbon nanotube or a surface modified short carbon nanotube. The surface modified short carbon nanotube is short carbon nanotubes grafted with functional groups on their surface, that is, the short carbon nanotubes are modified with functional groups on their surface. In the present disclosure, a surface modifying functional group in the surface modified short carbon nanotube is selected from the group consisting of amino, carboxyl, carbonyl and combinations thereof.

In the present disclosure, the surface modification can be realized by surface treatment (e.g, dipping) using a surface modifier that contains the corresponding surface modifying functional group. For example, for a carboxyl group, it can be obtained in a manner of placing carbon nanotubes in aqua regia for ultrasonic treatment, wherein when the carbon nanotubes are truncated into short carbon nanotubes, the surface of the carbon nanotubes is oxidized and thus grafted with carboxyl groups, so that carbon nanotubes with carboxyl groups are obtained. For an aminated carbon nanotube, it can be obtained in a manner of placing carbon nanotubes with carboxyl groups in ethylenediamine and a coupling agent for ultrasonic dispersion, so that carbon nanotubes grafted with amino groups are obtained. The coupling agent is preferably O-(7-azabenzotriazol-1-yl)-N,N,N′,N′-tetramethyluronium hexafluorophosphate (HATU). The mass ratio of the ethylenediamine to the coupling agent is preferably 1:(1-5). For a carbonylated carbon nanotube, it can be obtained in a manner of placing carbon nanotubes in potassium hydroxide solution for ultrasonic dispersion, so that carbon nanotubes grafted with carbonyl groups are obtained. In the above surface modification process, washing and drying are preferably performed after the ultrasonic treatment, so as to obtain carbon nanotubes grafted with functional groups on their surface.

In accordance with the present disclosure, raw materials forming the resin matrix slurry include a thermoset resin.

In the present disclosure, the thermoset resin is preferably selected from the group consisting of an epoxy resin, a polyester resin, a phenolic resin, a vinyl resin, a bismaleimide resinis and combinations thereof. The epoxy resin is preferably bisphenol A epoxy resins. In some embodiments of the present disclosure, the epoxy resin is bisphenol A epoxy resin Epon862.

In the present disclosure, short carbon nanotubes with different chemical modifications can be selected for different resin matrixes. Carbon nanotubes grafted with suitable functional groups can form covalent bonds or non-covalent bonds when they undergo a curing reaction with a resin matrix, enabling the fiber composite material to have a desired performance enhancement effect. In the present disclosure, the collocation of resin and surface modified short carbon nanotubes is preferably that: the resin is a bisphenol A epoxy resin and the short carbon nanotubes are amino-modified short carbon nanotubes. The two can form covalent bonds in the curing reaction, achieving a cross-linked structure, thereby greatly improving the mechanical properties of the matrix.

In accordance with the present disclosure, raw materials forming the resin matrix slurry include an additive.

In the present disclosure, the additive is a curing agent and/or an accelerating agent. The curing agent is preferably an amine-based curing agent, including but being not limited to one or more of D230 and dicyandiamide. The accelerating agent is preferably an amine-based accelerating agent, including but being not limited to one or more of DMP-30 and triethylamine.

In accordance with the present disclosure, a short carbon nanotube, a thermoset resin and an additive are mixed to obtain resin matrix slurry.

In the present disclosure, the mass ratio of the above three raw materials is preferably as follows: the mass of the short carbon nanotube is 0.1%-5% by mass of the thermoset resin, specifically 0.1%, 0.5%, 1.0%, 1.5%, 2.0%, 2.5%, 3.0%, 3.5%, 4.0%, 4.5% and 5.0%. The mass of the additive is 0.1%-50% by mass of the thermoset resin. The mass of the curing agent is 1%-50% by mass of the thermoset resin, specifically 1%, 5%, 10%, 15%, 20%, 25%, 30%, 35%, 40%, 45% and 50%. The mass of the accelerating agent is 0.1%-5% by mass of the thermoset resin, specifically 0.1%, 0.5%, 1.0%, 1.5%, 2.0%, 2.5%, 3.0%, 3.5%, 4.0%, 4.5% and 5.0%.

In the present disclosure, the order of mixing preferably specifically includes: firstly dispersing the short carbon nanotube in the thermoset resin, and then mixing them with the additive.

In the present disclosure, dispersing the short carbon nanotube in the thermoset resin can be carried out in a manner including, but being not limited to ultrasonication, ball milling, pan milling, mechanical stirring, microfluidic control and the like. When the short carbon nanotube and the thermoset resin is mixed, (1) the short carbon nanotube is directly dispersed in the thermoset resin, if the thermoset resin has a low viscosity (a viscosity of ≤1000 cps); (2) the short carbon nanotube is dispersed in an organic solvent firstly, then mixed with the thermoset resin, and then the organic solvent is removed, if the thermoset resin has a high viscosity (a viscosity of >1000 cps). The organic solvent is preferably alcohol or acetone. The removal of the organic solvent is preferably carried out in a manner of heating and stirring.

In the present disclosure, when the additive is mixed, the mixing manner is not limited, for example, these raw materials may be well mixed by using a conventional mixing manner in this field. After the mixing, further degassing is preferably carried out. After the above treatments, the resin matrix slurry is obtained.

[Regarding Step b]

In this step, the resin matrix slurry is poured into a fiber preform and subjected to curing-molding, to obtain the fiber composite material reinforced and toughened by long-short carbon nanotubes.

In accordance with the present disclosure, the fiber preform is used as a matix.

In the present disclosure, the fiber preform comprises an upper fiber fabric layer, a long carbon nanotube fiber veil layer and a lower fiber fabric layer which are sequentially laminated and contacted. Namely, the fiber preform is a sandwich structure, with the fiber fabric layers on both sides and the long carbon nanotube fiber veil layer in the middle. The terms “upper” and “lower” have no special orientation restrictions, but are used to merely indicate that they are located at both sides of the long carbon nanotube fiber veil layer, wherein any one side of the fiber fabric layer is an upper fiber fabric layer, and the other side of the fiber fabric layer will be naturally the lower fiber fabric layer.

In the present disclosure, the fiber fabric in the upper fiber fabric layer is a unidirectional fiber fabric or a multi-directional fiber fabric. In the present disclosure, the fiber fabric in the upper fiber fabric layer is preferably a continuous carbon fiber fabric, a continuous glass fiber fabric or a continuous aramid fiber fabric. In the present disclosure, the fiber fabric in the upper fiber fabric layer is a non-surface modified fiber fabric or a surface modified fiber fabric.

In the present disclosure, the fiber fabric in the lower fiber fabric layer is a unidirectional fiber fabric or a multi-directional fiber fabric. In the present disclosure, the fiber fabric in the lower fiber fabric layer is preferably a continuous carbon fiber fabric, a continuous glass fiber fabric or a continuous aramid fiber fabric. In the present disclosure, the fiber fabric in the lower fiber fabric layer is a non-surface modified fiber fabric or a surface modified fiber fabric.

In the present disclosure, the fiber fabric in the upper fiber fabric layer comprises one or more layers; the fiber fabric in the lower fiber fabric layer comprises one or more layers. The term “more layers” includes two layers or more than two layers. In the present disclosure, the layer number of the fiber fabric in the upper fiber fabric layer is preferably identical with the layer number of in the lower fiber fabric layer. In the present disclosure, in the upper fiber fabric layer, each layer of the fiber fabric has preferably the same type. In the present disclosure, in the lower fiber fabric layer, each layer of the fiber fabric has preferably the same type. In the present disclosure, the upper fiber fabric layer is preferably the same as the lower fiber fabric layer. Specifically, the fiber fabrics at corresponding positions on both sides are the same, with the long carbon nanotube fiber veil layer as the center. In some embodiments of the present disclosure, the upper fiber fabric layer comprises 6 layers of carbon fiber fabrics and the lower fiber fabric layer comprises 6 layers of carbon fiber fabrics.

In the present disclosure, fiber veils of the long carbon nanotube fiber veil layer located in the central interlayer of the fiber preform have a veil-like structure formed from a long carbon nanotube, i.e, a tulle (or called as tulle net) formed from a long carbon nanotube. The long carbon nanotube has a length distribution of 50-1000 μm; preferably, the long carbon nanotube has an average length of >100 μm. In the present disclosure, the long carbon nanofiber tube preferably has a diameter of 1-50 nm. In the present disclosure, the long carbon nanotube is a non-surface modified long carbon nanotube or a surface modified long carbon nanotube. The surface modified long carbon nanotube is a long carbon nanotube grafted with functional groups on the surface, that is, the surface has been modified with functional groups. In the present disclosure, the surface modifying functional group in the surface modified long carbon nanotube is selected from the group consisting of amino, carboxyl, carbonyl and combinations thereof. The manner of surface modification and the collocation of the surface modified carbon nanotube with the resin matrix are consistent with those of the short carbon nanotube, and thus will not be repeated here.

In the present disclosure, in the long carbon nanotube fiber veil layer, the long carbon nanotube fiber veil comprises one or more layers. In the present disclosure, the thickness of the long carbon nanotube fiber veil layer can be adjusted by controlling the deposition time of a single layer of the long carbon nanotube fiber veil or the number of laid layers of the long carbon nanotube fiber veil. In the present disclosure, the total thickness of the carbon nanotube fiber veil layer is preferably 1 μm.

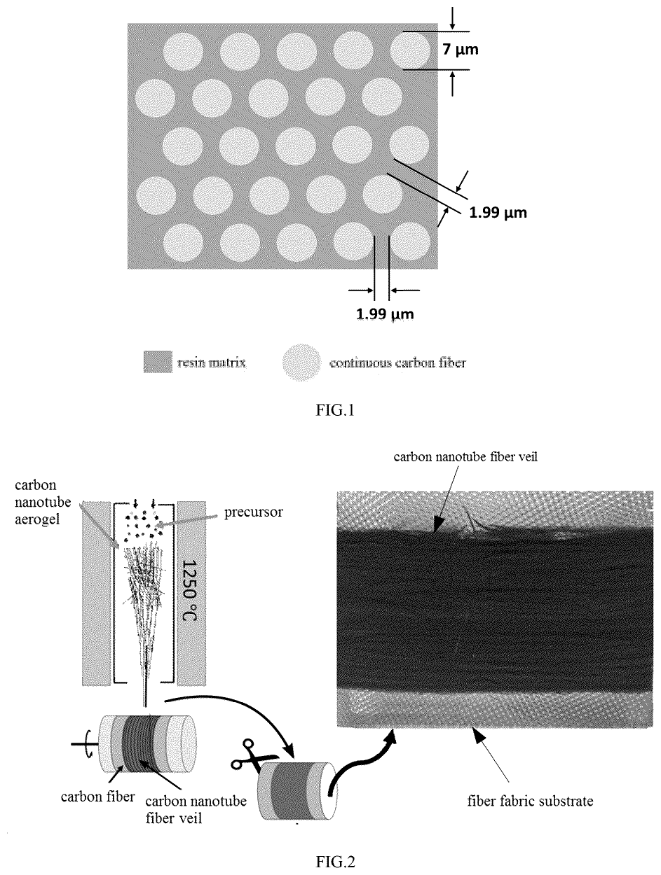

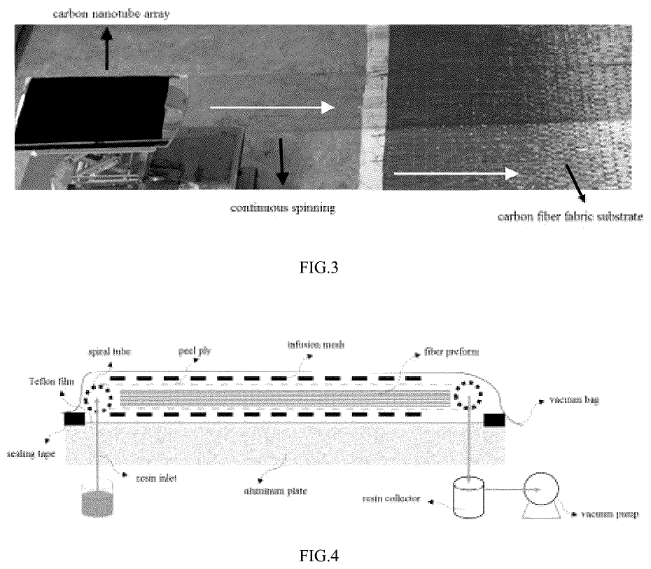

In the present disclosure, the long carbon nanotube fiber veil can be prepared in the following two manners. (1) It can be prepared by Floating Catalytic Chemical Vapor Deposition (FCCVD), whose specific procedure is shown in FIG. 2. A carbon source is cracked in a high-temperature reaction furnace and grows into carbon nanotubes on the surface of the catalyst; a large number of carbon nanotubes gather and entangle with each other to form carbon nanotube aerogels; the carbon nanotube aerogels are continuously pulled out from the other end of the high-temperature reaction furnace, and deposited on the surface of a fiber fabric substrate in situ to form a fluffy veil-like structure, that is, the long carbon nanotube fiber veil. (2) It can be prepared by an array spinning method, whose procedure is shown in FIG. 3. Firstly, a carbon nanotube array with a certain length is vertically elongated on a silicon substrate by chemical vapor deposition (CVD), and then attached, in the form of tulle, onto the surface of a fiber fabric substrate, through continuous spinning. In the present disclosure, the above preparation process preferably includes an acid treatment, after the carbon nanotube is obtained and before the tulle is prepared, for the removal of impurities such as metal catalysts, so as to improve the purity of the carbon nanotube. In the present disclosure, the purity of the carbon nanotube is preferably controlled equal to or more than 95%, which is conducive to reinforcement and toughening effects of the material.

In the above preparation process, the fiber fabric in the upper fiber fabric layer or the lower fiber fabric layer can be directly used as the substrate. The long carbon nanotube fiber veil layer is deposited and formed on the substrate, and then other fiber fabric layers are superimposed thereon, so that the fiber preform is formed.

In the present disclosure, the mass of the long carbon nanotube is preferably 0.1%-5% by mass of the thermoset resin in step a), specifically, 0.1%, 0.5%, 1.0%, 1.5%, 2.0%, 2.5%, 3.0%, 3.5%, 4.0%, 4.5% and 5.0%. The long carbon nanotube fiber veil layer consists of the long carbon nanotube, so the mass of the long carbon nanotube represent the mass of the long carbon nanotube fiber veil layer.

In the present disclosure, the total mass of the upper fiber fabric and the lower fiber fabric is preferably 40%-80% by mass of the composite material. Specifically, it is equivalent to that the mass ratio of the total mass of the upper fiber fabric and the lower fiber fabric to the mass of the resin matrix slurry obtained in step a) is (0.67-4): 1, specifically 0.67:1, 0.70:1, 1:1, 2:1, 3:1 and 4:1. Controlling the above-mentioned dosage ratio can not only make the preparation smoothly, but also improve the reinforcement and toughening effects of the composite material. If the content of the fiber fabric is too low, it will not be able to effectively achieve the reinforcement and toughening effect. If the content of the fiber fabric is too high, it will be difficult to perform the preparation smoothly and obtain a homogeneous composite, and also adversely affects the material properties.

In the present disclosure, the resin matrix slurry obtained in step a) is poured into the fiber preform and curing-molding is performed. In the present disclosure, step a) can be carried out by a manner including, but being not limited to vacuum assisted resin transfer molding (VARTM), RTM molding, hand lay-up molding or the like, preferably vacuum assisted resin transfer molding (VARTM). The operation of pouring resin matrix slurry into a fiber preform by vacuum assisted resin transfer molding (VARTM) is shown in FIG. 4. The resin matrix slurry is uniformly introduced into the fiber preform under the negative pressure of a vacuum pump. At this time, due to factors such as pressure difference and viscosity, there will be enrichment of the resin at the inlet end, which will easily lead to uneven thickness of the composite material plate. One method that can effectively alleviate this situation is: after the front end of the resin matrix slurry flow arrives at the outlet, first closing the inlet of the resin, and after the excess resin is sucked out, closing the outlet. In the process, a double-layer infusion mesh is used to promote the two-direction diffusion of the resin on the in-plane and out-of-plane of the fiber preform. The infusion mesh and the fiber fabric are separated by a peel ply to facilitate demoulding. Finally, it is sealed in a vacuum bag for later use.

In the present disclosure, after the above pouring operation, curing-molding is performed. In the present disclosure, the curing-molding is carried out at a temperature of preferably ranging from 25 to 500° C. and a pressure preferably ≤10 MPa. For different resins and curing agents, the temperature and pressure can be adjusted within the above-mentioned ranges. For example, for an Epon862 epoxy resin and a D-230 curing agent system, the curing conditions are: firstly curing at 80° C. for 2 h, and then curing at 120° C. for 2 h. In the case of pouring a sample using vacuum assisted resin transfer molding (VARTM), after the pouring is completed, the entire VARTM platform can be moved into an oven for curing, or pressurized on a flat vulcanizing machine for curing. After the curing is completed, cooling and demoulding are carried out to obtain a fiber composite material product reinforced and toughened by long-short carbon nanotubes.

The present disclosure further provides a fiber composite material product reinforced and toughened by long-short carbon nanotubes prepared by the method described in the above-mentioned technical solutions.

In accordance with the preparation method provided by the present disclosure, during the mutual infiltration between resins and fibers, short carbon nanotubes can easily penetrate through the narrow gaps between fibers and be evenly dispersed in the composite material. Long carbon nanotubes are laid, in the form of fiber veils, on the surface of the fiber fabric, before the resin matrix slurry is poured. This effectively solves the problem of difficult dispersion of long carbon nanotubes, and effectively alleviates the “fiber filtration effect” of carbon nanotubes that often occurs in the VARTM process. The spatial layout of long and short carbon nanotubes in the composite material is optimized, namely, short carbon nanotubes will effectively pass through the narrow gaps between the fibers and are evenly distributed throughout the fiber composite plates, and the long carbon nanotubes are enriched in the interlaminar region of the composite material plates. This enables carbon nanotubes to fully exert their excellent mechanical properties, simultaneously achieving the dual purposes of the intralaminar reinforcement and the interlaminar toughening of the fiber composite material. In a word, the present invention not only effectively avoids the “fiber filtration effect” of carbon nanotubes generally occurring in the VARTM process, which enables the short carbon nanotubes to evenly disperse in the fiber composite material and simultaneously to effectively fill the gaps between the fiber composite material layers or resin-enriched regions, but also effectively increases interfacial bonding forces between layers by reinforcing the connection between layers of the fiber composite material by the long carbon nanotubes, so that the prepared composite material has excellent mechanical properties such as strength and toughness and physical properties such as thermal and electrical properties.

The test results show that the composite material prepared by the present disclosure exhibited a bending strength equal to or greater than 600 MPa, which increased by 6% as compared with the reference sample, and a type I interlaminar fracture toughness equal to or greater than 1500 J/m², which increased by 150% as compared with the reference sample.

To further aid in understanding of the present disclosure, preferred embodiments of the present disclosure will be described below in conjunction with examples. However, it should be understood that these descriptions are only for further illustrating the features and advantages the present disclosure, rather than limiting the claims of the present invention.

### EXAMPLES

### Example 1

### S1. Preparation of Aminated Short Carbon Nanotubes

10 g of carbon nanotubes were poured into a beaker containing 300 mL of aqua regia, and subjected to a 2.5 KW ultrasonication treatment at 70° C. for 12 h, to obtain short carbon nanotubes with a length distribution of 0.5-3 μm and an average length of 2 μm. In the above process of truncating the carbon nanotubes, the surface of carbon nanotubes were oxidized and grafted with carboxyl groups. The short carbon nanotubes with carboxyl groups were put into a mixed solution of ethylenediamine and HATU coupling agent (the mass ratio of ethylenediamine to coupling agent was 1:1-5), and subjected to 2.5 KW ultrasonic dispersion at room temperature for 12 h. After that, the resulting nanotubes were washed several times with anhydrous ethanol and deionized water and dried, to obtain about 10 g of short carbon nanotubes with amino groups grafted on the surface.

### S2. Preparation of a Fiber Preform

A carbon fiber unidirectional fabric (Toray T300-3000, density 1.76 g/cm³) was cut into 30×30 cm fabric pieces, which were then manually laid in a laminating manner according to [0]₆ₛ to form a fiber preform (see FIG. 5). Specifically, 6 layers of the cut fabric pieces were laminated as a lower fiber fabric layer, which is used as a substrate. A carbon nanotube array with a certain length was vertically elongated on a silicon substrate by chemical vapor deposition (CVD), and then attached in a form of tulle by continuous spinning on the substrate of the above-mentioned fiber fabric layer, to form a long carbon nanotube fiber veil layer (3 layers were laid in total with a total thickness of 300 nm, wherein the length distribution of the long carbon nanotube was 50-1000 μm). A double cantilever beam sample (according to the requirements of the ASTM D5528 test standard) was prepared by covering a PTFE film (with a thickness of 25 μm) on a long carbon nanotube fiber veil layer, and inserting it at the end part of the middle layer to cover an area about 60 mm wide, so as to form a pre-crack of a certain length (for the preparation of double cantilever beam specimens). Then, 6 layers of the cut fabric pieces were laminated upon the above-mentioned sample as an upper fiber fabric layer. A fiber preform, with a structure as shown in FIG. 5, consisting of 6 layers of carbon fiber unidirectional fabric, a long carbon nanotube fiber veil layer and 6 layers of carbon fiber unidirectional fabric was obtained. It is noted that in the above-mentioned preparation process, the PTFE film is laid only to prepare the double cantilever beam sample for subsequent performance testing; in the actual production process of the composite material, the PTFE film is not laid, that is, the actual composite material product does not contain a PTFE film.

### S3. Preparation of Resin Matrix Slurry

Using a microfluidic device, 2.4 g of the aminated short carbon nanotubes obtained in step S1 were uniformly dispersed in acetone, poured into a beaker containing 355 g of the bisphenol A epoxy resin Epon862, and mechanically stirred at 1000 r/min in a water bath at a temperature 60° C. for 6 h. After acetone was completely volatilized, 125 g of a curing agent D-230 was added and mechanically stirred at room temperature at 500 r/min for 10 min. At last, the mixture was degassed at 25° C. in a vacuum oven for 10 min, to obtain 482.4 g of resin matrix slurry.

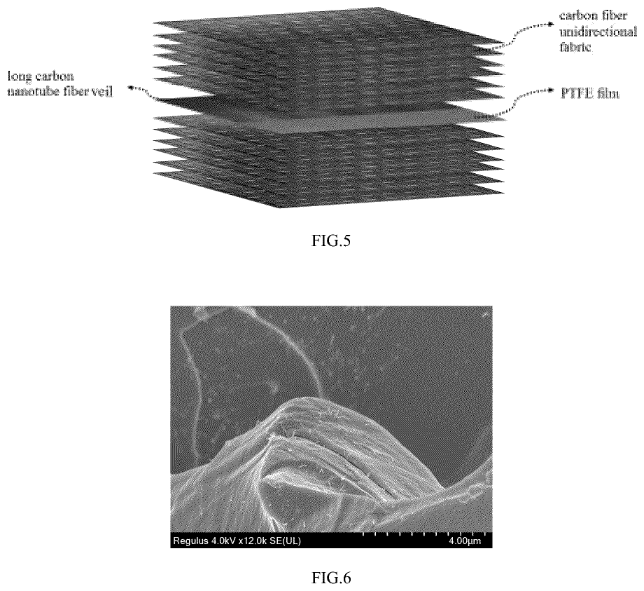

The cured sample of the obtained resin matrix slurry was subjected to brittle fracture at low temperature after being cured, and observed under SEM. The result is shown in FIG. 6. It can be seen from FIG. 6 that short carbon nanotubes are uniformly dispersed in the resin.

### S4. Preparation of a Composition Material

The built VARTM platform is shown in FIG. 4. A double-layer infusion mesh was used for the fiber preform, and the infusion mesh and the fiber preform were separated by a peel ply. The resin matrix slurry was uniformly introduced into the fiber preform under the negative pressure of a vacuum pump. At this time, due to factors such as pressure difference and viscosity, there will be enrichment of the resin at the inlet end, which will easily lead to uneven thickness of the composite material plate. To alleviate such situation, after the front end of the resin matrix slurry flow arrived at the outlet, first the inlet of the resin was closed, and after the excess resin was sucked out, the outlet was closed. After the resin matrix slurry was completely poured into the fiber preform, the entire VARTM platform was moved into an oven, first cured at 80° C. for 2 h and then cured at 120° C. for 2 h. Subsequently, it was cooled and demolded, to obtain a composite material plate.

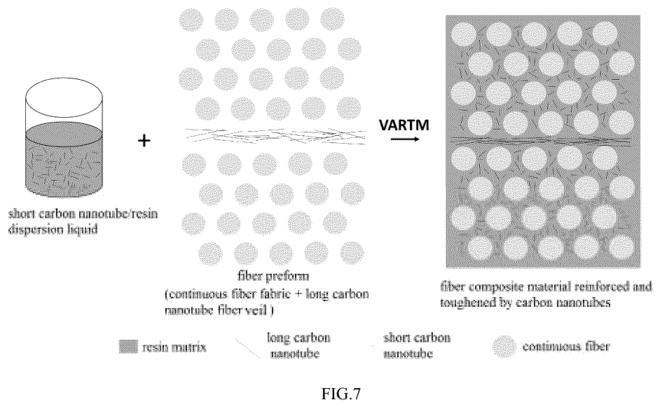

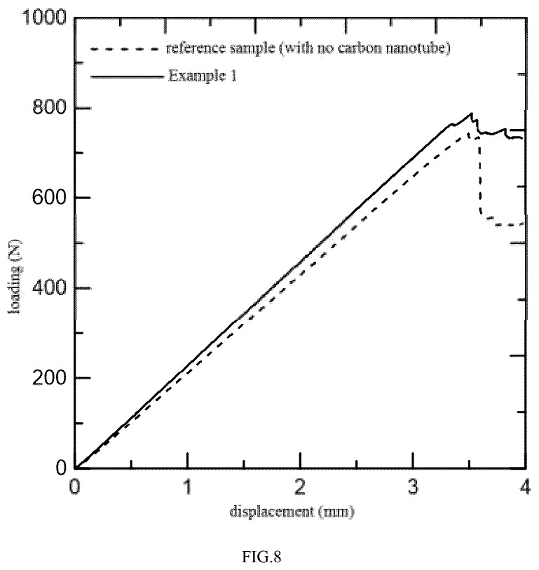

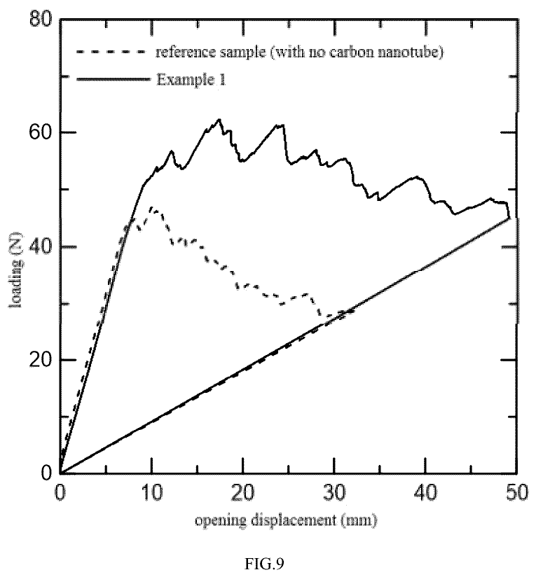

The above-described entire preparation process of Example 1 is shown in FIG. 7. FIG. 7 is a schematic graph showing the preparation process in Example 1.

### Comparative Example 1

Preparation of a Reference Sample (with No Carbon Nanotube):

The reference sample was prepared according to Example 1, except that the preparation of the fiber preform in step S2 did not use the long carbon nanotube fiber veil layer, and the preparation of the resin matrix slurry in step S3 did not use the short carbon nanotube.

### Example 2: Test

### (1) Strength Testing

With reference to ASTM D790, the samples of Example 1 and Comparative Example 1 were tested for three-point bending strength. The results are shown in FIG. 8. FIG. 8 is a typical load-displacement curve graph of the samples of Example 1 and Comparative Example 1. The bending strength of the sample of Example 1 was calculated as 624 MPa. The bending strength of the sample of Comparative Example 1 was calculated as 589 MPa.

### (2) Fracture Toughness Testing

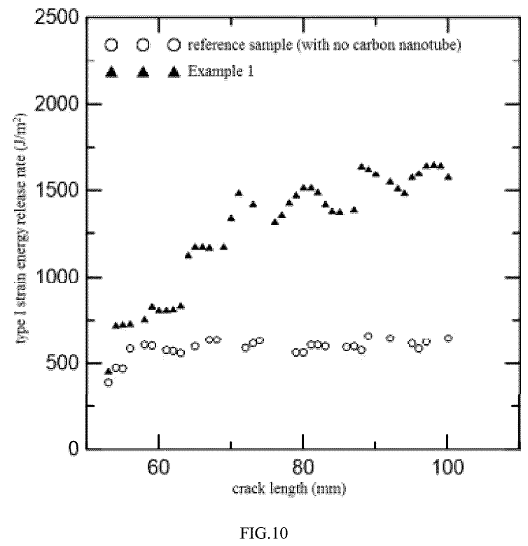

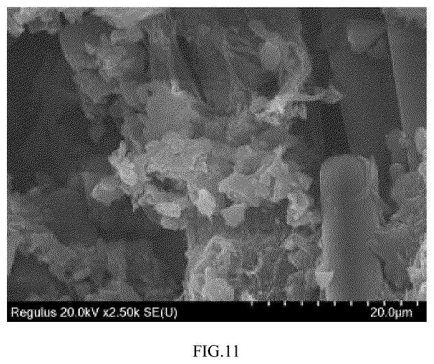

The samples of Example 1 and Comparative Example 1 were tested for fracture toughness according to ASTM D5528. The results are shown in FIGS. 9-10. FIG. 9 is a load-opening displacement curve graph of the samples of Example 1 and Comparative Example 1. FIG. 10 is a R-curve (a curve of crack growth resistance against crack growth) graph of the samples of Example 1 and Comparative Example 1

It can be seen that, compared with the reference sample of Comparative Example 1, the I-type interlaminar fracture toughness of the composite material plate of Example 1 increased from 607 J/m² to 1536 J/m² by more than 150%, indicating that the synergistic toughening mechanism of long/short carbon nanotubes proposed in the present disclosure is high-efficiency.

### (3) Interlaminar Structure Characterization

The fractured sample of Example 1 after fracture toughness testing in section (2) was characterized. The results are shown in FIG. 11. FIG. 11 is an SEM image of the interlaminar structure of the fractured sample in Example 1. It can be seen that long carbon nanotubes are enriched in the interlaminar region of the composite material.

Specific examples are described herein to illustrate the principle and implementation of the present disclosure, but these examples, including the best mode, are only intended to aid in understanding of the method and core concept of the present invention, and to enable any one of the skilled in the art to implement the present invention including any device or system in manufacture and use, as well as any combined methods. It should be noted that for those skilled in the art, various improvements and modifications may be made without departing from the principle of the present disclosure, and these improvements and modifications should also fall within the protection scope of the present invention. The protection scope of this patent is defined by the claims, and also covers other embodiments that a person skilled in the art would know. The said other embodiments should also be included in the scope of the claims, if they contain structural elements that are similar with the literal expression of claims, or contain equivalent structural elements that are not substantially different from the literal expression of the claims.

1. A method of preparing a fiber composite material reinforced and toughened by long-short carbon nanotubes, comprising:
step a), mixing a short carbon nanotube, a thermoset resin and an additive to obtain resin matrix slurry; and
step b), pouring the resin matrix slurry into a fiber preform and curing-molding, to obtain the fiber composite material reinforced and toughened by long-short carbon nanotubes;
wherein the fiber preform comprises an upper fiber fabric layer, a long carbon nanotube fiber veil layer and a lower fiber fabric layer, which are sequentially laminated and contacted;
the long carbon nanotube fiber veil layer has a veil-like structure formed by the long carbon nanotube;
the short carbon nanotube has a length of 0.5-3 μm and an average length of ≤2 μm; and
the long carbon nanotube has a length of 50-1000 μm.

2. The method according to claim 1, wherein the short carbon nanotube is a non-surface modified short carbon nanotube or a surface modified short carbon nanotube;
the long carbon nanotube is a non-surface modified long carbon nanotube or a surface modified long carbon nanotube;
a surface modifying functional group in the surface modified short carbon nanotube is selected from the group consisting of amino, carboxyl, carbonyl and combinations thereof; and
a surface modifying functional group in the surface modified long carbon nanotube is selected from the group consisting of amino, carboxyl, carbonyl and combinations thereof.

3. The method according to claim 1, wherein the thermoset resin is selected from an epoxy resin, a polyester resin, a phenolic resin, a vinyl resin, a bismaleimide resin and combinations thereof.

4. The method according to claim 1, wherein the short carbon nanotube is 0.1%-5% by mass of the thermoset resin;
the long carbon nanotube is 0.1%-5% by mass of the thermoset resin; and
a total mass of the upper fiber fabric and the lower fiber fabric is 40%-80% by mass of the composite material.

5. The method according to claim 1, wherein the fiber fabric in the upper fiber fabric layer is a unidirectional fiber fabric or a multi-directional fiber fabric;
the fiber fabric in the lower fiber fabric layer is a unidirectional fiber fabric or a multi-directional fiber fabric;
the fiber fabric in the upper fiber fabric layer is a continuous carbon fiber fabric, a continuous glass fiber fabric or a continuous aramid fiber fabric;
the fiber fabric in the lower fiber fabric layer is a continuous carbon fiber fabric, a continuous glass fiber fabric or a continuous aramid fiber fabric;
the fiber fabric in the upper fiber fabric layer is a non-surface modified fiber fabric or a surface modified fiber fabric; and
the fiber fabric in the lower fiber fabric layer is a non-surface modified fiber fabric or a surface modified fiber fabric.

6. The method according to claim 1, wherein the fiber fabric in the upper fiber fabric layer comprises one or more layers; and
the fiber fabric in the lower fiber fabric layer comprises one or more layers.

7. The method according to claim 1, wherein the additive is a curing agent and/or an accelerating agent;
the curing agent is used in an amount of 1%-50% by mass of the thermoset resin; and
the accelerating agent is used in an amount of 0.1%-5% by mass of the thermoset resin.

8. The method according to claim 1, wherein the pouring of the resin matrix slurry into a fiber preform in step b) is carried out by a vacuum assisted resin transfer molding process.

9. The method according to claim 1, wherein the curing-molding in step b) is carried out at a temperature of 25-500° C. and a pressure of ≤10 MPa.

10. A fiber composite material reinforced and toughened by long-short carbon nanotubes prepared by the method according to claim 1.
